(19) United States
(12) Patent Application Publication
(10) Pub. No.: US 2014/0209838 A1
(43) Pub. Date: Jul. 31, 2014

(54) METHOD OF FABRICATING SILICON CARBIDE

(71) Applicants: Jung Eun Han, Seoul (KR); Byung Sook Kim, Seoul (KR); Gun Young Gil, Seoul (KR)

(72) Inventors: Jung Eun Han, Seoul (KR); Byung Sook Kim, Seoul (KR); Gun Young Gil, Seoul (KR)

(73) Assignee: LG INNOTEK CO., LTD., Seoul (KR)

(21) Appl. No.: 14/241,934

(22) PCT Filed: Aug. 8, 2012
(86) PCT No.: PCT/KR2012/006301

§ 371 Date: Apr. 1, 2014

(30) Foreign Application Priority Data
Aug. 31, 2011 (KR) 10-2011-0088195

(51) Int. Cl. C01B 31/36

(52) U.S. Cl. CPC C01B 31/36
USPC 252/500; 423/345

(57) ABSTRACT

A method of fabricating silicon carbide according to the embodiment comprises the steps of preparing a mixture by mixing a silicon source comprising silicon with a solid carbon source or a carbon source comprising an organic carbon compound; supplying binder into the mixture to granulate the mixture; and reacting the granulated mixture.

### TECHNICAL FIELD

The embodiment relates to a method of fabricating silicon carbide.

### BACKGROUND ART

Recently, silicon carbide has been used in various electronic devices as a semi-conductor material for various purposes. In particular, the silicon carbide is very useful because the silicon carbide has the superior physical strength and high resistance against the chemical attack. In addition, the silicon carbide represents the superior electronic characteristics, such as the high radiation hardness, high breakdown filed, relatively wide bandgap, high saturated electron drift velocity, high operating temperature, and high absorption and emission of quantum energy in the blue, violet and ultraviolet bands of a spectrum.

The silicon carbide can be fabricated by mixing and heating source materials, such as a silicon source and a carbon source. Generally, in fabrication of the silicon carbide, a solid-phase raw material is input into a crucible and synthesized in the crucible. A silicon carbide powder may be scattered due to reaction gas generated during a synthesis reaction, for example, CO gas. Particularly, the silicon carbide powder may be frequently scattered due to reaction gas during reaction caused by the small grain size of the silicon carbide powder. The scattering may reduce the recovery rate of the silicon carbide powder.

A conventional scheme for fabricating the silicon carbide powder uses an Acheson scheme, a carbon-thermal reduction scheme, a liquid polymer thermal decomposition scheme, and a CVD (Chemical Vapor Deposition) scheme. In particular, the liquid polymer thermal decomposition scheme or the carbon-thermal reduction scheme is used for synthesizing a high purity silicon carbide powder.

That is, a silicon source is mixed with a carbon source, and the carbonization process and the synthesis process on the mixture are performed to synthesize silicon carbide.

A reaction formula of the silicon carbide powder is as follows.

SiO₂(s)+3C(s)→SiC(s)+2CO(g)

For example, the Acheson scheme is a representative scheme of synthesizing the silicon carbide. The Acheson scheme is a scheme which fabricates silicon carbide by mixing a silicon source with a carbon source, and flowing an electric current through the mixture to be reacted at the high temperature in the range of about 2200° C. to 2400° C.

Further, a CVD synthesis scheme synthesizes silicon carbide by reacting gas containing silicon and carbon. The CVD synthesis comprises a thermal decomposition CVD scheme and a plasma CVD scheme. In this case, SiCl₂ gas or SiH₂ gas may be used as the silicon source, and CH₄ gas, C₃H₄ gas, or CCl₄ gas may be used as the carbon source.

Further, the liquid polymer thermal decomposition scheme or the carbon-thermal reduction scheme is used for synthesizing a high-purity fine carbon silicon powder at a low temperature, and the high-purity fine carbon silicon powder is fabricated using ethyl silicate and phenol resin as a carbon source and a silicon source.

However, when synthesizing the silicon carbide by the foregoing scheme, because most mixture powder of a silicon source and a carbon source serving as raw materials of synthesizing the silicon carbide is configured by fine powder, the scattering of the powder due to the small grain size of the powder during reaction may be caused by reaction gas, namely, CO gas of the reaction formula.

Accordingly, the recovery rate of the silicon carbide, which is a final synthetic product, may be lowered due to scattering of the mixture powder.

Therefore, in fabrication of the silicon carbide powder, it is important to increase the recovery rate of the silicon carbide powder from the mixture materials.

### DISCLOSURE OF INVENTION

### Technical Problem

The embodiment provides a method of fabricating silicon carbide, capable of increasing the recovery rate of the silicon carbide by reducing the scattering of the source material, which is caused by reaction gas during the reaction.

### Solution to Problem

A method of fabricating silicon carbide powder according to the embodiment comprises the steps of preparing a mixture by mixing a silicon source comprising silicon with a solid carbon source or a carbon source comprising an organic carbon compound; supplying binder into the mixture to granulate the mixture; and reacting the granulated mixture.

A method of fabricating silicon carbide powder according to another embodiment comprises the steps of preparing a mixture by mixing a silicon source comprising silicon with a solid carbon source or a carbon source comprising an organic carbon compound; supplying solvent comprising water, alcohol, or acetone into the mixture to granulate the mixture; and reacting the granulated mixture.

### Advantageous Effects of Invention

According to the method of fabricating silicon carbide of the embodiment, after the silicon carbide powder is mixed, a solvent comprising a binder, water, alcohol or acetone is supplied to granulate a particle of the silicon carbide powder.

As the silicon carbide powder is granulated, a weight of the powder particle may be increased. A discharge passage of reaction gas is enlarged, so that discharge speed may be reduced.

Accordingly, the scattering of the silicon carbide powder caused by CO gas generated during the reaction can be reduced, thereby increasing the recovery rate of the silicon carbide.

### BRIEF DESCRIPTION OF DRAWINGS

FIG. 1 is a flowchart showing a method of fabricating silicon carbide according to the embodiment.

### MODE FOR THE INVENTION

Hereinafter, a method of fabricating silicon carbide according to the embodiment will be described in detail with reference to accompanying drawings.

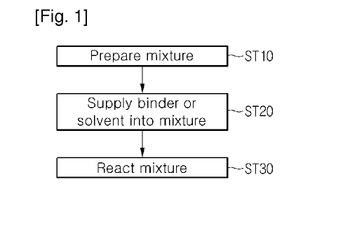

FIG. 1 is a flowchart showing a method of fabricating the silicon carbide powder according to the embodiment.

Referring to FIG. 1, the method of fabricating the silicon carbide according to the embodiment comprises the steps of preparing a mixture by mixing a silicon source comprising silicon with a solid carbon source or a carbon source comprising an organic carbon compound (ST10); supplying binder into the mixture to granulate the mixture (ST20); and reacting the granulated mixture (ST30).

Hereinafter, each step of the method will be described in more detail.

In step ST10 of preparing the mixture, the silicon (Si) source and the carbon (C) source are prepared and mixed to form a mixture material.

The silicon source may comprise various materials capable of providing silicon. For instance, the silicon source may comprise at least one selected from the group consisting of silica sol, silicon dioxide, fine silica and quartz powder, but the embodiment is not limited thereto. For instance, an organic silicon compound comprising silicon may be used as the silicon source.

The carbon source may comprise a solid carbon source or an organic carbon compound.

The solid carbon source may comprise a carbon black, a carbon nano tube (CNT), or fullerene (C₆₀).

The organic carbon compound may comprise at least one selected from the group consisting of phenol resin, franc resin, xylene resin, polyimide, polyurethane, poly-acrylonitrile, polyvinyl alcohol, cellulose, sugar, pitch, and tar.

The carbon source and the silicon source may be mixed with each other through the wet mixing process using the solvent or the dry mixing process without using the solvent. According to the wet mixing process, the carbon source can be conglomerated with the silicon source, so that the productivity can be improved. In addition, according to the dry mixing process, the cost for the solvent can be saved, the pollution caused by the solvent can be prevented, and the carbonization process can be omitted, so that the process can be simplified.

The silicon source and the carbon source are mixed by using a ball mill or an attrition mill to recover mixture powder. The mixture powder can be recovered by filtering the mixture through a sieve.

The silicon source and the carbon source can be mixed in a predetermined mass ratio. For instance, a mole ratio of carbon comprised in the carbon source to silicon comprised in the silicon source (hereinafter, referred to as mole ratio of carbon to silicon) is in the range of about 1:1.5 to about 1:3. If the mole ratio of carbon to silicon exceeds 3, the amount of carbon is so excessive that the amount of residual carbon, which does not participate in the reaction, is increased, lowering the recovery rate. In addition, if the mole ratio of carbon to silicon is less than about 1.5, the amount of silicon is so excessive that the amount of residual silicon, which does not participate in the reaction, is increased, lowering the recovery rate. That is, the mole ratio of carbon to silicon must be determined by taking the recovery rate into consideration.

Since the silicon source is volatilized into a gas phase at the high temperature during the reaction, the mole ratio of carbon to silicon is set in the range of about 1.8 to about 2.7.

The silicon source is uniformly mixed with the carbon source to form the mixture.

After that, in step ST20 of supplying a binder into the mixture to granulate the mixture, the binder may be supplied into the mixture to granulate the mixture.

Here, the granulating refers to an operation of conglomerating a mixture of the silicon source and the carbon source, namely, powder obtained by combining the silicon source with the carbon to form a big particle.

The binder may comprise various materials capable of conglomerating silicon. For instance, the binder may comprise oligomer or polymer. The oiligomer may be carbon-based oiligomer. The oiligomer or the polymer may comprise resin materials such as phenol resin, urethane resin, polyvinyl alcohol, or polyglycol.

The binder conglomerates the mixture. That is, the binder may granulate the mixture of the silicon source and the carbon source to conglomerate particles of the mixture. In this case, the binder has contents in the range of about 1 weight % to about 10 weight % based on the mixture. Preferably, the binder has contents in the range of about 1 weight % to about 5 weight % based on the mixture.

The binder is dissolved in solvent capable of dissolving the binder and may be supplied into the mixture in a spray scheme. For example, the solvent may be alcohol-based or water-based material. When a predetermined time, for example, about five minutes to 10 minutes elapse after the binder has been supplied into the mixture, the binder is absorbed in the mixture and the mixture is granulated due to the binder, so that particles are conglomerated.

At this time, instead of supplying solvent in which the binder is dissolved, solvent having water, alcohol, or acetone may be supplied into the silicon carbide powder. The solvent comprising the water, the alcohol, or the acetone may granulate the mixture of the silicon source and the carbon source to conglomerate the particles. In this case, the solvent comprising the water, the alcohol, or the acetone has contents in the range of about 1 weight % to about 20 weight % based on the mixture. Preferably, the solvent comprising the water, the alcohol, or the acetone has contents in the range of about 1 weight % to about 10 weight % based on the mixture.

In step ST30 of reacting the mixture, the granulated mixture is subject to the reaction to form the silicon carbide. In detail, mixture powder is weighed in a graphite crucible and then the mixture powder is supplied and heated in a high-temperature reaction furnace, such as a graphite furnace. The process to form the silicon carbide may be classified into the carbonization process and the synthesis process.

In the carbonization process, the organic carbon compound is carbonized so that carbon is produced. The carbonization process is performed at the temperature in the range of about 600° C. to about 1200° C. In detail, the carbonization process is performed at the temperature in the range of about 800° C. to about 1100° C. If the solid carbon source is used as the carbon source, the carbonization process may be omitted.

After that, the synthesis process is performed. In the synthesis process, the silicon source is reacted with the solid carbon source or the organic carbon compound, so that the silicon carbide is formed through following reaction formulas 1 to 3.

### [Reaction Formula 1]

SiO₂(s)+C(s)→SiO(g)+CO(g)

### [Reaction Formula 2]

SiO(g)+2C(s)→SiC(s)+CO(g)

### [Reaction Formula 3]

SiO₂(s)+3C(s)→SiC(s)+2CO(g)

In order to facilitate the above reaction, the heating temperature is set to about 1300° C. or above. If the heating temperature is set in the range of about 1300° C. to about 1900° C., the fabricated silicon carbide may have the β type, which is the low-temperature stable phase. The silicon carbide having the β type consists of fine particles, so the strength of the silicon carbide can be improved. However, the embodiment is not limited thereto. For instance, if the heating temperature exceeds about 1800° C., the silicon carbide may have the a type, which is the high-temperature stable phase. The synthesis process may be performed for about 1 hour to about 7 hours.

Accordingly, silicon carbide powder is granulated by the solvent having binder or water, alcohol or acetone, and particles of the silicon carbide powders are conglomerated with each other, thereby preventing the scattering of the silicon carbide powder caused by CO gas during the reaction.

That is, because the silicon carbide powder is granulated by the binder or solvent, particles of the silicon carbide powder are conglomerated with each other to increase a weight. Accordingly, the scattering of the silicon carbide due to the CO gas during the reaction may be reduced. In addition, since the particles are conglomerated with each other by the binder or the solvent, passages between the particles are enlarged, so that discharge speed of the CO gas during reaction is reduced, thereby preventing the scattering.

Hereinafter, the method of fabricating the silicon carbide powder according to the embodiments and comparative example will be described in more detail. The following embodiments are illustrative purpose only and the disclosure is not limited to the embodiments.

### EMBODIMENT 1

About 1 g of fumed silica and about 1.2 g of phenol resin were mixed to prepare mixture 1. At this time, the average grain size of the fumed silica was about 30 nm and the residual rate of carbon in the phenol resin after the carbonization process was about 60%. In addition, about 6kg of the source material was input in the crucible of 500 φ×100 H.

A silicon source was mixed with a carbon source and 10 weight % of alcohol was supplied into the mixture.

After that, the mixture 1 was subject to the carbonization process at the temperature of about 850° C. for five hours while rising the temperature at the rate of 3° C./min and then subject to the synthesis process at the temperature of about 1700° C. for three hours while rising the temperature at the rate of 5° C./min, thereby forming silicon carbide powder 1.

The reaction was started at the initial vacuum degree of 5×10−2 Torr or less and continued by operating a rotary pump.

### EMBODIMENT 2

Mixture 2 was prepared by mixing fumed silica and phenol resin under the same composition and same condition of embodiment 1 except that 5 weight % of phenol resin was supplied instead of 10 weight % of alcohol.

Then, the carbonization process and the synthesis process were carried out under the same condition of embodiment 1, thereby forming silicon carbide 2.

### EMBODIMENT 3

Mixture 3 was prepared by mixing fumed silica and phenol resin under the same composition and same condition of embodiment 1 except that 10 weight % of alcohol and 5 weight % of phenol resin were supplied instead of 10 weight % of alcohol.

Then, the carbonization process and the synthesis process were carried out under the same condition of embodiment 1, thereby forming silicon carbide 3.

### Comparative Example 1

Silicon carbide 4 was formed in the same manner as that of embodiment 1 except that argon gas was not supplied.

The recovery rate of the silicon carbide fabricated according to embodiments 1 to 3 and comparative example 1 is shown in Table 1.

TABLE 1

| sample | Recovery rate (wt %) |
|---|---|
| Embodiment 1 | 31 |
| Embodiment 2 | 27 |
| Embodiment 3 | 23 |
| Comparative example 1 | 16 |

Referring to Table 1, the recovery rate of the silicon carbide according to embodiments 1 to 3 is higher than the recovery rate of the silicon carbide powder according to comparative example 1. Thus, if the binder or water, alcohol or acetone is supplied into the silicon carbide powder, the recovery rate of the silicon carbide can be increased.

That is, silicon carbide powder mixed with the binder or the water, the alcohol or the acetone granulated, so that particles are conglomerated with each other. Accordingly, a weight of mixture particles is increased, and a passage between particles is enlarged, thereby preventing the scattering of the silicon carbide powder due to CO gas during the reaction.

Any reference in this specification to “one embodiment,” “an embodiment,” “example embodiment,” etc., means that a particular feature, structure, or characteristic described in connection with the embodiment is comprised in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

1. A method of fabricating silicon carbide, the method comprising:
preparing a mixture by mixing a silicon source comprising silicon with a carbon source
supplying binder into the mixture to granulate the mixture; and
reacting the granulated mixture,
wherein the carbon source comprises a solid carbon or an organic carbon compound,
wherein the binder has contents in a range of about 1 weight % to about 10 weight % based on the mixture.

2. The method of claim 1, wherein the binder comprises at least one selected from the group consisting of phenol resin, urethane resin, polyvinyl alcohol and polyglycol.

3. The method of claim 1, wherein the binder has contents in a range of about 1 weight % to about 5 weight % based on the mixture.

4. The method of claim 1, wherein the silicon source comprises at least one selected from the group consisting of silica sol, silicon dioxide, fine silica and quartz powder.

5. The method of claim 1, wherein the solid carbon source comprises at least one selected from the group consisting of a carbon black, a carbon nano tube (CNT) and fullerene (C60),
wherein the organic carbon compound comprises at least one selected from the group consisting of phenol resin, franc resin, xylene resin, polyimide, polyurethane, polyacrylonitrile, polyvinyl alcohol, cellulose, sugar, pitch and tar.

6. The method of claim 1, wherein a mole ratio of silicon of the silicon source to carbon of the carbon source is about 1:1.5 to about 1:3.

7. The method of claim 1, wherein the binder is dissolved in a solvent and supplied into the mixture in a spray scheme.

8. A method of fabricating silicon carbide, the method comprising:
preparing a mixture by mixing a silicon source comprising silicon with a carbon source;
supplying a solvent comprising water, alcohol, or acetone into the mixture to granulate the mixture; and
reacting the granulated mixture,
wherein the carbon source comprises a solid carbon or an organic carbon compound,
wherein the solvent has contents in a range of about 1 weight % to about 20 weight % based on the mixture.

9. The method of claim 8, wherein the solvent has contents in a range of about 1 weight % to about 10 weight % based on the mixture.

10. The method of claim 8, wherein the silicon source comprises at least one selected from the group consisting of silica sol, silicon dioxide, fine silica and quartz powder.

11. The method of claim 8, wherein the solid carbon source comprises at least one selected from the group consisting of a carbon black, a carbon nano tube (CNT) and fullerene (C60),
wherein the organic carbon compound comprises at least one selected from the group consisting of phenol resin, franc resin, xylene resin, polyimide, polyurethane, polyacrylonitrile, polyvinyl alcohol, cellulose, sugar, pitch and tar.

12. The method of claim 8, wherein a mole ratio of silicon of the silicon source to carbon of the carbon source is about 1:1.5 to about 1:3.
